(19) United States
(12) Patent Application Publication
(10) Pub. No.: US 2025/0347224 A1
(43) Pub. Date: Nov. 13, 2025

(54) METHOD OF MINING USING A DISC CUTTER

(71) Applicants: ELEMENT SIX (UK) LIMITED, Didcot, Oxfordshire (GB); ELEMENT SIX GMBH, Burghaun (DE)

(72) Inventors: Shuo Lu, Didcot, Oxfordshire (GB); Habib SARIDIKMEN, Didcot, Oxfordshire (GB); Markus BENING, Burghaun (DE)

(21) Appl. No.: 18/864,810

(22) PCT Filed: May 5, 2023
(86) PCT No.: PCT/EP2023/061966

§ 371 Date: Nov. 11, 2024

(30) Foreign Application Priority Data
May 12, 2022 (GB) 2206925.6

(51) Int. Cl. E21C 25/18; E21C 37/00

(52) U.S. Cl. CPC E21C 25/18; E21C 37/00

(57) ABSTRACT

There is provided a method of mining rock using a disc cutter comprising a cutter body with a diameter, d, and a thickness, t, a plurality of tool holders mounted about a peripheral surface of the cutter body and a plurality of cutting elements attached to the tool holders, the method comprising the steps: —cutting a first slot in the rock at a first cutting position of the disc cutter, —moving the disc cutter to a second cutting position which is to the left or right of the first cutting position, and —cutting a second slot in the rock, such that the second slot is spaced apart from the first slot by distance S, at least one of the first and second slots having a depth of slot D, and wherein a ratio of depth of slot D, to distance S, is in the range of 2 to 16.

### FIELD OF THE INVENTION

This disclosure relates to a method of mining materials using a disc cutter. In particular, it relates to a method of mining rock using a disc cutter comprising polycrystalline diamond cutters. More particularly, it relates to a method of mining cuboidal blocks from material such as kimberlite and granite.

### BACKGROUND

GB2589736 discloses a disc cutter 10 comprising a cutter body 14, a plurality of tool holders 16 and a plurality of cutting elements 18 mounted to the tool holders 16, as shown in FIGS. 1 and 2. The cutting elements 18 are arranged in the tool holders 16 according to a sequence that reduces the cutting forces during use. In one particular embodiment, six or more disc cutters 10 are arranged on a mutual drive spindle, regularly spaced apart from one another. The spacing of the disc cutters 10 is selected according to the depth of cut required in the target rock formation and the mechanical properties of the rock.

A problem with this arrangement is that it is difficult to achieve perfect cutting synchronisation of the various disc cutters when they engage with the rock. No portion of rock ever has exactly the same mechanical properties as the adjacent portion of rock, thus some disc cutters cut relatively easily and others face more resistance. Consequently, this causes problems with the governing cutting assembly, leading to stoppages and mechanical faults. It can also lead to inconsistent slot depths.

It is an object of this invention to address the issue above.

### STATEMENT OF INVENTION

In accordance with a first aspect of the invention, there is provided a method of mining rock using a disc cutter comprising a cutter body with a diameter, d, and a thickness, t, a plurality of tool holders mounted about a peripheral surface of the cutter body and a plurality of cutting elements attached to, e.g. mounted in, the tool holders, the method comprising the steps:
cutting a first slot in the rock at a first cutting position of the disc cutter,
moving the disc cutter to a second cutting position which is, e.g., to the left or right of the first cutting position, and
cutting a second slot in the rock, such that the second slot is spaced apart from the first slot by distance S, at least one of the first and second slots having a depth of slot D, and wherein a ratio of depth of slot D, to distance S, is in the range of 2 to 16.

In accordance with a second aspect of the invention, there is provided a method of mining rock using a disc cutter comprising a cutter body with a diameter, d, a plurality of tool holders mounted about a peripheral surface of the cutter body and a plurality of cutting elements attached to, e.g. mounted in, the tool holders, the method comprising cutting a depth of slot D in the rock at a cutting position of the disc cutter, wherein a ratio of the depth of slot D to the diameter d of the cutter body is from approximately 0.15 to approximately 0.50.

As an option, the ratio of the depth of slot D to the diameter d of the cutter body is from approximately 0.15, approximately 0.20, approximately 0.25, approximately 0.30 or approximately 0.35 to approximately 0.49, approximately 0.48, approximately 0.47, approximately 0.46, approximately 0.45 or approximately 0.40.

As an option, the ratio of the depth of slot D to the diameter d of the cutter body is from approximately 0.15 to approximately 0.50, or from approximately 0.15 to approximately 0.49, or from approximately 0.15 to approximately 0.48, or from approximately 0.15 to approximately 0.47, or from approximately 0.15 to approximately 0.46, or from approximately 0.20 to approximately 0.45, or from approximately 0.25 to approximately 0.40, or from approximately 0.30 to approximately 0.40, or from approximately 0.35 to approximately 0.40, or from approximately 0.32 to approximately 0.37, or from approximately 0.34 to approximately 0.37, or from approximately 0.34 to approximately 0.36.

Further preferable and/or optional features of the first and second aspects of the invention are provided in the dependent claims.

### BRIEF DESCRIPTION OF THE DRAWINGS

The improved method of mining shall now be described by way of example and with reference to the accompanying drawings in which:

FIG. 1 shows a perspective view of a prior art disc cutter;

FIG. 2 shows an expanded partial view of the disc cutter of FIG. 1;

FIG. 3 shows a schematic of first and second slots cut into rock, and introduces parameters used to define the method of mining in accordance with the invention;

FIG. 4 is a graph of computer modelled force (N) required to break concrete at the bottom of the slot, considering slot spacing (mm) and depth of slot (mm);

FIG. 5 is a graph of computer modelled force (N) required to break granite at the bottom of the slot, considering slot spacing (mm) and depth of slot (mm);

FIG. 6 is a graph showing the maximum principal stress at different heights of the slot;

FIG. 7 is a graph showing the maximum principal stress at different hammer impact angles;

FIGS. 8a, 8b and 8c show finite element analysis images of an indentation formed in the first slot by a particular type of rock breaking tool, and in particular the stress region around the indention from which a crack propagates towards the second slot;

FIG. 9 is a plan view of one example of a rock breaker tool;

FIG. 10 is a perspective view of the rock breaker tool of FIG. 9 in use in a mine environment;

FIG. 11 is a perspective view of another example of a rock breaker tool;

FIG. 12 is a perspective view of the rock breaker tool of FIG. 11 in use in a mine environment; and

FIG. 13 is a schematic plan view of another example of a rock breaker tool in use in a mine environment.

### DETAILED DESCRIPTION

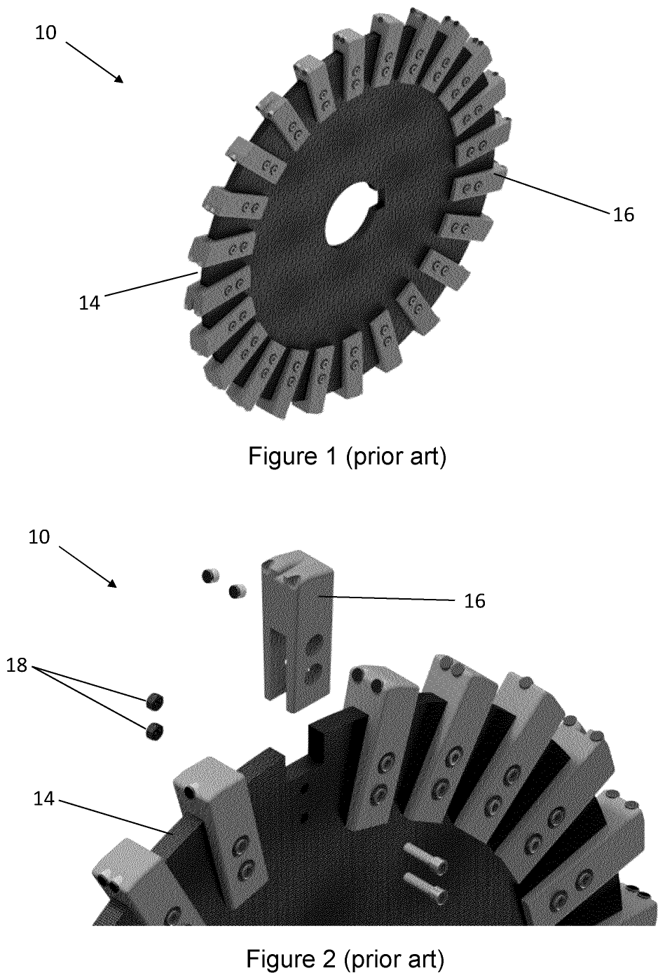

A disc cutter 10 such as the one shown in FIGS. 1 and 2 is used to cut into rock 12. The disc cutter 10 comprises a cutter body 14 with a diameter, d, and a thickness, t, a plurality of tool holders 16 mounted about a peripheral surface of the cutter body 14 and a plurality of cutting elements 18 mounted in the tool holders 16. The cutting elements 18 are arranged in a sequence within each repeating sets of tool holders 16. The cutting elements 18 comprise polycrystalline diamond.

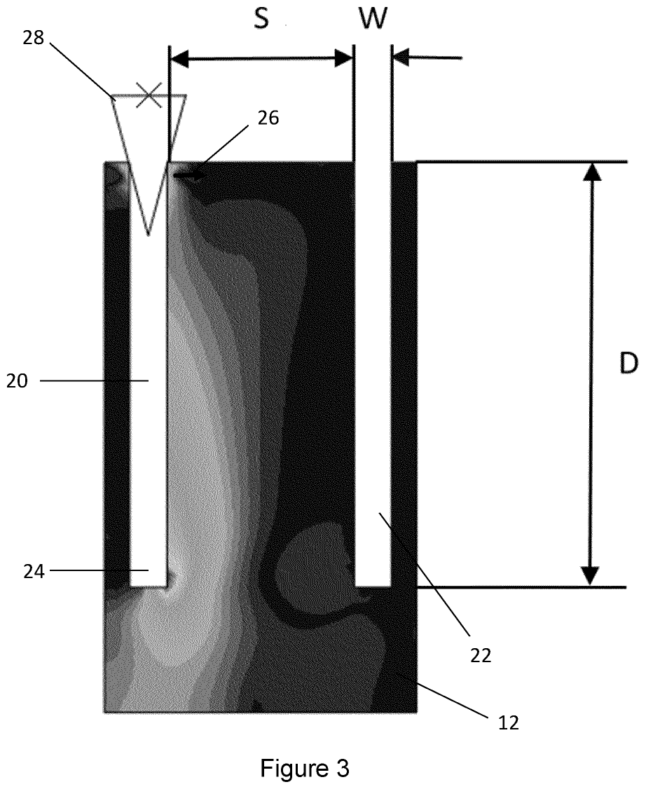

In use, the disc cutter 10 is rotated at speed and offered up to the rock 12. As the disc cutter advances and engages with the rock 12, cutting begins and a first slot 20 is progressively formed in the rock 12—see FIG. 3. Once a target depth of slot, D, has been achieved, the disc cutter 10 is then withdrawn from the slot. The disc cutter 10 is moved to a second cutting position, and the cutting operation repeated to form a second slot 22. The second slot 22 may to be to the left or right of the first slot 20 in the rock face, or alternatively, it may be above or below the first slot 20. The second slot 22 is spaced apart from the first slot 20 by distance, S. The distance S equates to the spacing between slots 20, 22. In order to minimise the energy required for subsequent rock breakage, a ratio of depth of slot D to distance S must be in the range of 2 to 16. This range has been identified based on the computer simulation work described below. The distance S and depth of slot D are optimised based on the nature of the rock 12, and indirectly take into account the design of the cutter body 12.

The diameter of the cutter body 14 is in the range of from approximately 1.0 to approximately 5.0 m, for example, from approximately 1.0 m to approximately 4.0 m, for example from approximately 1.0 m to approximately 3.0 m, for example from approximately 1.0 to approximately 2.0 m, for example from approximately 1.0 m to approximately 1.8 m, for example 1.0 to 1.8 m. In one embodiment, the diameter of the cutter body 14 is 1.0 m. In another embodiment, the diameter of the cutter body 14 is 1.5 m. In a further embodiment, the diameter of the cutter body 14 is 1.75 m.

The first and/or second slot has a width, W, which is less than the thickness, t, of the cutter body 14. The slot 20, 22 has a width which is in the range of 20 to 80 mm. In practical terms, a slot width of 20 mm is recommended for a rock material with an Unconfined Compressive Strength of over 200 MPa. Similarly, a slot width of 40 mm is recommended for a rock material with an Unconfined Compressive Strength in the range of 150 to 200 MPa. A slot width of 60 mm is recommended for a rock material with an Unconfined Compressive Strength in the range of 60 to 150 MPa. A slot width of 80 mm is recommended for a rock material with an Unconfined Compressive Strength in the range of 30 to 60 MPa. An alternative term for Unconfined Compressive Strength is Uniaxial Compressive Strength.

### Computer Simulation Using Finite Element Analysis

According to the International Society for Rock Mechanics and Rock Engineering (ISRM), rock strength can be described as medium strength, high strength and very high strength, as shown in Table 1. More quantitively, Uniaxial Compressive Strength, or UCS, is the most widely quoted parameter to describe the nature of rock and it is a significant factor to consider when designing for rock cutting. In short, strong rock requires higher forces to be applied before it will break. Examples of Medium Strength rock include concrete and sandstone. An example of High Strength rock is kimberlite. An example of Very High Strength rock is granite. Concrete and granite, representing two ends of the extreme, are specifically considered in this disclosure.

TABLE 1
extract taken from ‘A review of rock cutting
for underground mining: past, present and future’, D. Vogt,
published in The Journal of the Southern African Institute of
Mining and Metallurgy, Volume 116, November 2016.
Table I
Description of rock strength (ISRM 1980)

| Strength description | UCS (MPa) |
|---|---|
| Extremely low strength | <1 |
| Very low strength | 1-5 |
| Low strength | 5-25 |
| Medium strength | 25-50 |
| High strength | 50-100 |
| Very high strength | 100-250 |
| Extremely high strength | >250 |

In the study, depth of slot D and distance (also referred to as ‘spacing’) S were investigated. The choice of D and S will directly affect the load required when the rock 12 is broken from the base 24 of the slot, near its floor. The loading condition was to apply a horizontal force to the top edge of the slot, indicated generally at 26. The output variable was Maximum Principle Stress. It should also be noted that, for the purpose of this study, the rock damage initiation criteria is defined as when the Maximum Principal Stress reaches the Uniaxial Compressive Strength.

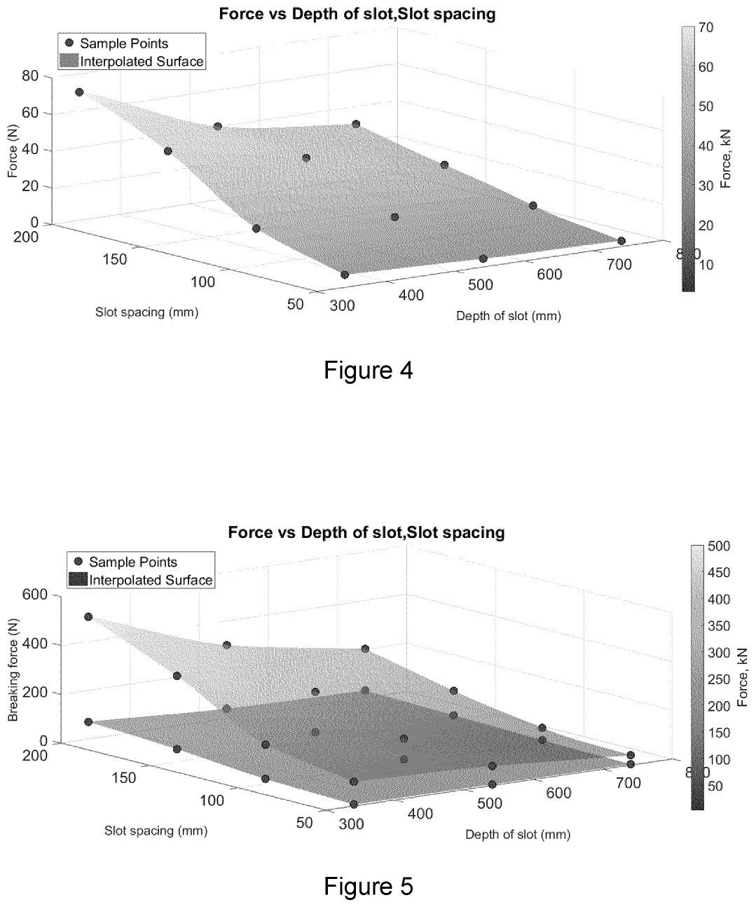

The simulation results for concrete and granite are provided in Tables 2 and 3 respectively. The same results are also shown in FIGS. 4 and 5.

TABLE 2
Concrete

| Depth of | Spacing | | Uniaxial | |
|---|---|---|---|---|
| the slot, | between the | Ratio of | compressive | Load |
| D (mm) | slots, S (mm) | D/S | stress (MPa) | (kN) |
| 340 | 50 | 6.8 | 36 | 7 |
| 340 | 100 | 3.4 | 30 | 20 |
| 340 | 150 | 2.3 | 37.7 | 50 |
| 340 | 200 | 1.7 | 32.7 | 70 |
| 540 | 50 | 10.8 | 33 | 4.5 |
| 540 | 100 | 5.4 | 37.2 | 15 |
| 540 | 150 | 3.6 | 43 | 35 |
| 540 | 200 | 2.7 | 30 | 40 |
| 740 | 50 | 14.8 | 34 | 3 |
| 740 | 100 | 7.4 | 35.1 | 10 |
| 740 | 150 | 4.9 | 34 | 20 |
| 740 | 200 | 3.7 | 31 | 30 |

TABLE 3
Granite

| Depth of | Spacing | | Uniaxial | |
|---|---|---|---|---|
| the slot, | between the | Ratio of | compressive | Load |
| D (mm) | slots, S (mm) | D/S | stress (MPa) | (kN) |
| 340 | 50 | 6.8 | 230 | 100 |
| 340 | 100 | 3.4 | 240 | 160 |
| 340 | 150 | 2.3 | 264 | 350 |
| 340 | 200 | 1.7 | 234 | 500 |
| 540 | 50 | 10.8 | 245 | 70 |
| 540 | 100 | 5.4 | 248 | 100 |
| 540 | 150 | 3.6 | 246 | 200 |
| 540 | 200 | 2.7 | 225 | 300 |
| 740 | 50 | 14.8 | 220 | 40 |
| 740 | 100 | 7.4 | 210 | 60 |
| 740 | 150 | 4.9 | 204 | 120 |
| 740 | 200 | 3.7 | 207 | 200 |

A similar simulation was also carried out on kimberlite, which has a Uniaxial Compressive Strength of 50 to 100 MPa, but the results are not provided here.

When the ratio of depth, D, to distance, S, falls below 2, the load required to break the rock using a rock breaker tool 28 becomes unfeasibly high, requiring increasingly higher energy consumption to drive the disc cutter 10 and produce the cuts. A ratio higher than 15 is not achievable using the currently available size of disc cutters, mentioned herein.

The rock breaker tool 28 may take one of several different forms. The tool 28 may be a wedging tool such as the one shown in FIG. 3. As the wedging tool is gradually inserted into the slot 20, 22, bending forces are generated at the base of the slot 20, 22, which lead eventually to cracking in the rock 12. Alternatively, the rock breaker tool 28 may be configured to generate an indentation in the rock. Other configurations of rock breaker tool are described in more detail below. It should be noted that the rock breaker tool 28 is entirely optional and not essential to the invention. When the ratio of depth, D, to distance, S, becomes too high, the rock is likely to break under its own load and vibration. Thus, the rock breaker tool 28 is not required in all circumstances. It is preferable to use one though because when rock otherwise breaks, it tends to do so in an uncontrolled manner, resulting in greater wastage.

In general, the greater the depth of slot D, the higher the cutting efficiency. However, as the depth of slot D is increased, the torque and vibration on the cutter body are also increased, increasing the risk of inefficient excavation. There is therefore a balance to be had between depth of slot D and the diameter d of the cutter body 20, and this can be characterised by the ratio of the depth of slot D to the diameter d of the cutter body 20. For efficient cutting, this parameter is ideally at least 0.15, 0.20, 0.25, 0.30 or 0.35 and/or less than 0.50, 0.49, 0.48, 0.47, 0.46, 0.45 or 0.40. For example, the ratio of the depth of slot D to the diameter d of the cutter body 20 may be from approximately 0.15 to approximately 0.50, or from approximately 0.15 to approximately 0.49, or from approximately 0.15 to approximately 0.48, or from approximately 0.15 to approximately 0.47, or from approximately 0.15 to approximately 0.46, or from approximately 0.20 to approximately 0.45, or from approximately 0.25 to approximately 0.40, or from approximately 0.30 to approximately 0.40, or from approximately 0.35 to approximately 0.40, or from approximately 0.32 to approximately 0.37, or from approximately 0.34 to approximately 0.37, or from approximately 0.34 to approximately 0.36. A depth of slot, D, of 340 mm is achievable in practice using a cutter body 14 with a diameter of 1.0 m. This gives a ratio of depth of slot D to diameter d of the cutter body of 0.34. A depth of slot, D, of 540 mm is achievable in practice using a cutter body 14 with a diameter of 1.5 m. This gives a ratio of depth of slot D to diameter d of the cutter body of 0.36. A depth of slot, D, of 740 mm is achievable in practice using a cutter body 14 with a diameter of 1.75 m (giving a ratio of depth of slot D to diameter d of the cutter body of 0.42); however, a depth of slot, D of 640 mm (giving a ratio of depth of slot D to diameter d of the cutter body of 0.37) was considered preferable during an initial field test with the same size diameter.

Since the failure at the base 24 of the slot (i.e. furthermost from the opening into the slot) may be due to tensile stress, and the ratio of Uniaxial Compressive Strength to tensile stress is about 10, the real force (load, kN) required may be up to 10 times lower.

In real mining applications, the locations where damage may occur include the following conditions:
when the stress at the loading contact point exceeds Uniaxial Compressive Strength of the rock material;
when the tensile stress exceeds the maximum tensile strength (usually at the bottom of the slot); and
where there are microcracks.

Therefore, the principle of slot size selection is that the stress at the loading contact point should not exceed the Uniaxial Compressive Strength of the rock material, otherwise the rock will break at the loading point.

The stress at the loading contact point depends on the shape of the rock breaker tool 28 (e.g. wedging tool) and its contact area, and the loading conditions, such as the angle of incidence and whether they are dynamic.

As part of the study, the height of the loading contact point within the slot 20, 22 was also investigated. This was to try and identify the optimum position in which to apply the rock breaker tool 28 after the slots had been formed.

It was found that:
loading at the top position can produce the greatest bending stress at the bottom/base of the slot; and
when the height decreases, the bending stresses decrease linearly.

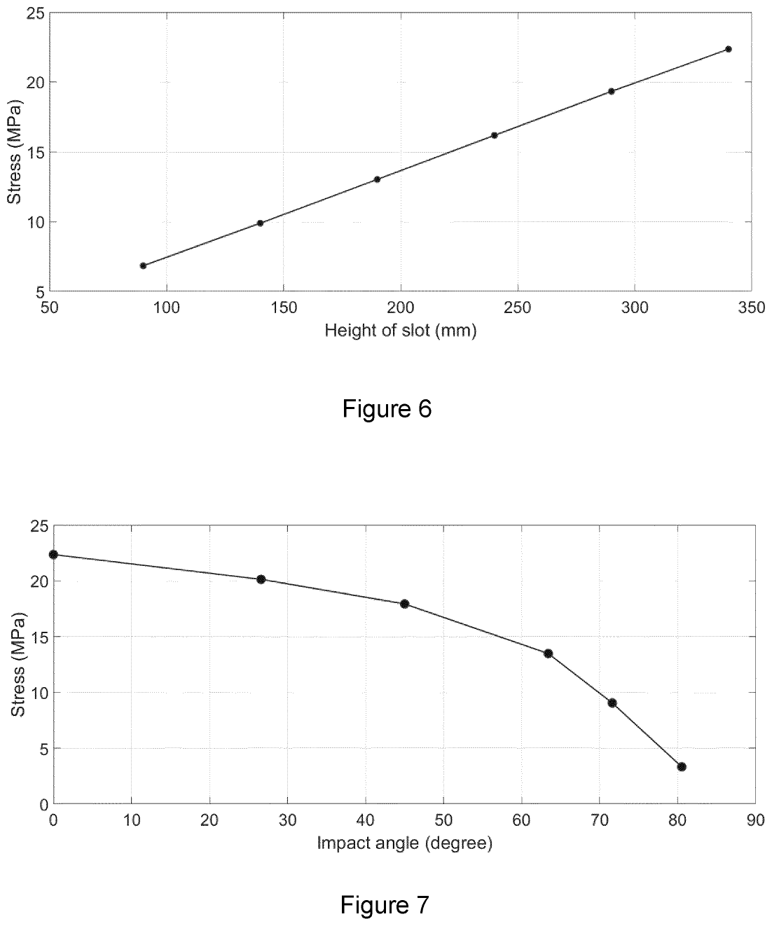

FIG. 6 shows that loading at different positions of the rock requires different loads to make the rock break. The ‘height of the slot’ is measured away from the opening of the slot, at the edge, towards the floor of the slot. The results show that the closer to the edge (near arrow 26) of the rock 12, the smaller the load required. However, in practice, the best position is not necessarily at the top of the slot 20, 22 since the impact of a rock breaker tool 28 may cause damage to the rock 12 at that point. The best contact position may indeed be at a lower position, deeper into the slot. Preferably, the rock breaker tool 28 contacts the rock at a position that is located at least 15% of the way into the slot. If the position is less than 15% of the way into the slot 20, 22, unwanted damage is more likely since the rock strength at the edge reduces dramatically due to the unconfined real-life condition.

The study also encompassed investigating the load required for breaking rock at different incident angles. Specifically, the relationship between the bending stress at the bottom of the slot and a variable loading angle was considered. The results are shown in FIG. 7, in which an ‘impact angle’ of zero represents the condition whereby the load of the rock breaker tool 28 is applied horizontally.

It was found that:
Horizontal loading will produce the greatest bending stress. As the angle increases, the bottom bending stress will decrease accordingly, as shown in FIG. 7.

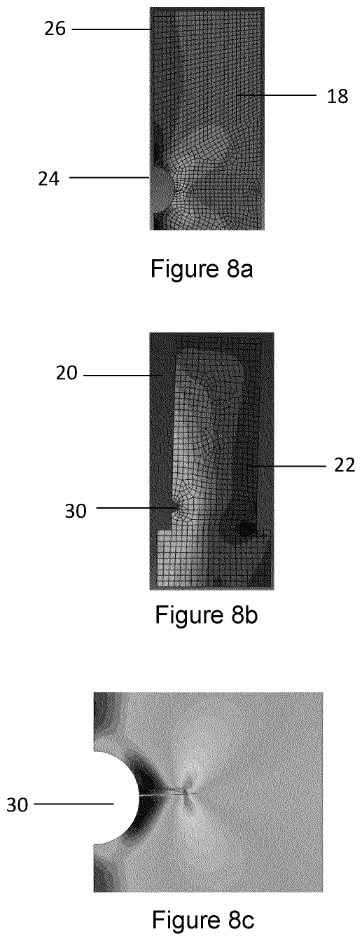

A final aspect of the study was to investigate how indentation affects crack initiation and propagation—see FIGS. 8a, 8b and 8c. One or more indentions 30 were formed in the rock using a hammer, a type of rock breaking tool 28. Based on the simulation, it was found that:
Cracks tend to propagate along the indentation direction; and
The spacing between the indention and the indentation depth substantially affect the crack propagation between indentations.

It is therefore preferable that an indentation 30 is formed in each of the first and second slots 20, 22, the two indentations facing each other. In this way, by controlling the spacing between a pair of first and second slots 20, 22, cracks can be predictably initiated and prompted to extend between indentations 30. They also reduce the breaking force required. The or each indentation 30 may be formed to a depth that is up to 95% of the distance, S, or up to 90% of the distance, S, or up to 85% of the distance, S, or up to 80% of the distance, S, or up to 75% of the distance, S, or up to 70% of the distance, S, or up to 65% of the distance, S, or up to 60% of the distance, S, or up to 55% of the distance, S, or up to 50% of the distance, S, or up to 45% of the distance, S, or up to 40% of the distance, S, or up to 35% of the distance, S, or up to 30% of the distance, S, or up to 25% of the distance, S, or up to 20% of the distance, S, or up to 15% of the distance, S, or up to 10% of the distance S, or up to 5% of the distance, S. Preferably, the or each indentation 30 is formed to a depth that is 20% of the distance, S. These factors help facilitate retrieval of the rock above the line of crack propagation in generally cuboidal blocks.

The expression ‘facing each other’ is intended to mean that the cross-section of the indentation reduces in the direction the indentation faces. For example, if the indentation was conical, then the direction to which the apex points is the direction that the indentation faces. The hemispherical indentation shown in FIG. 8a is facing to the right of the page.

Preferably, the or each indentation 30 is formed at or proximate to a floor of the slot 20, 22.

As mentioned previously, the rock breaker tool 28 may be configured in several other ways.

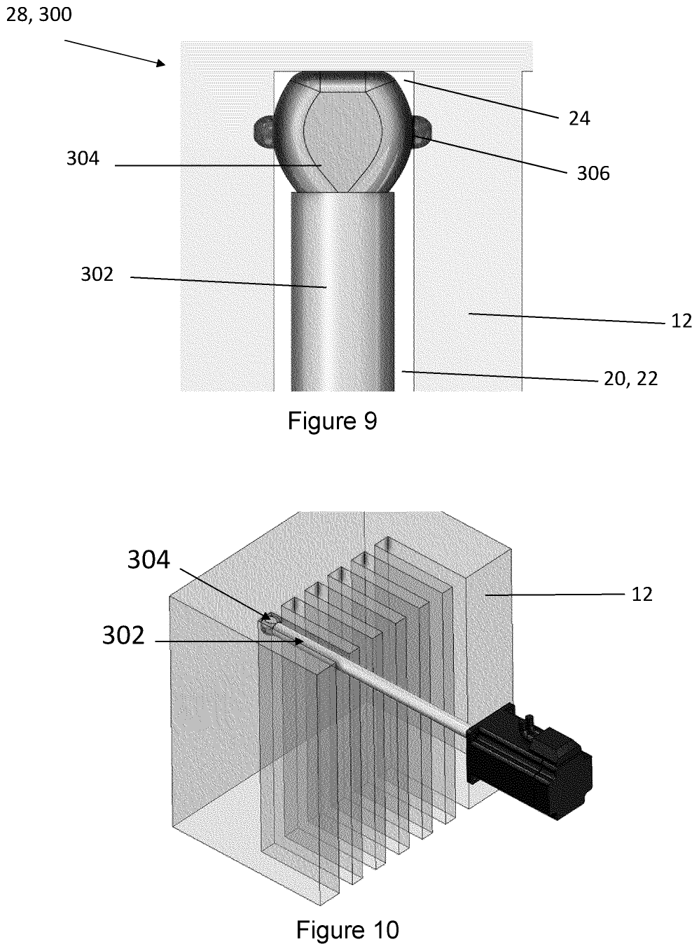

In the example shown in FIGS. 9 and 10, the rock breaker tool 28, 300 comprises an elongate tool body 302 having a longitudinal axis, and a tool head 304 at one end of the tool body 302. The tool head 304 comprises one or more projections 306 extending from a surface thereof. To facilitate rock breakage, the rock breaker tool 28, 300 is inserted at least partially into the slot 20, 22. The rock breaker tool 28, 300 is slowly rotated about the longitudinal axis, from an insertion orientation to a rock breaking orientation. In this manner, the tool head 304, or more specifically the projection(s) 306, thereby impinges on at least one adjacent pillar of rock 12. This impingement can be sufficient to generate cracks in the rock 12, which facilitates subsequent retrieval of the broken rock formation. This slow rotation rock breaking advantageously uses the least energy to break the rock at the base of the slot 20, 22. Optionally, the tool head 304 is configured to impinge on two adjacent pillars of rock 12.

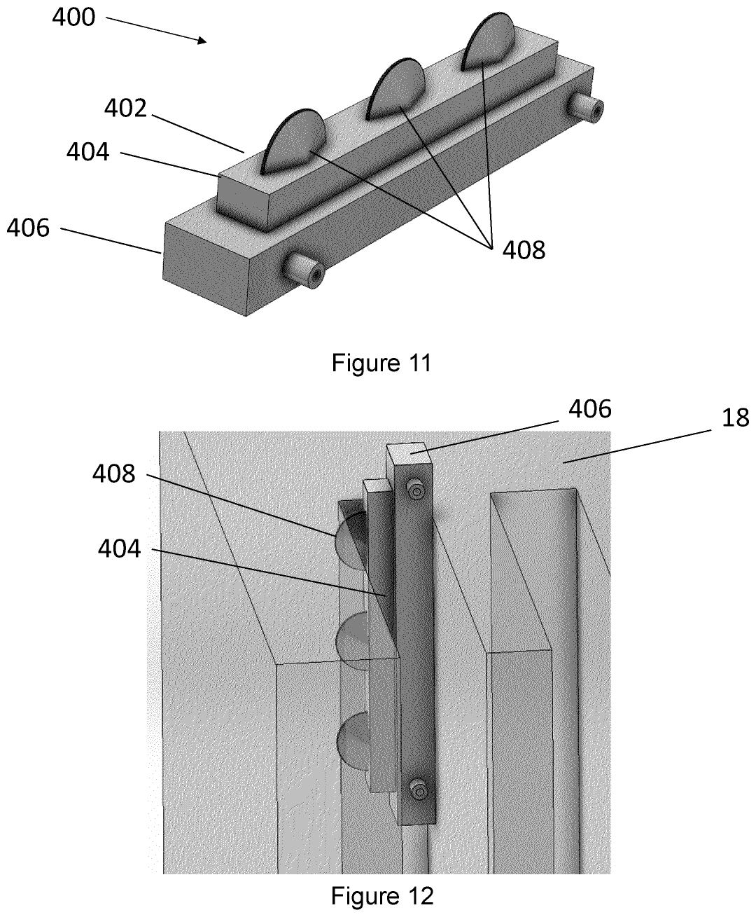

In the example shown in FIGS. 11 and 12, the rock breaker tool 28, 400 comprises a tool head 402, in which the tool head 402 comprising an elongate disc carrier 404, a base mount 406, and one or more mini disc cutters 408 supported by the disc carrier 404. The disc carrier 404, and therefore the mini disc cutters 408 too, is moveable relative to the base mount 406. Preferably, the tool head 402 comprises three or more mini disc cutters 408 spaced out along the disc mount 406. The mini disc cutters 408 preferably comprise carbide material. Distinct from the primary disc cutter 10, the mini disc cutters 408 have a compressed pyramidal shape with a circular base and low height.

Each mini disc cutter 408 may extend in a plane that is orthogonal to the longitudinal plane of the disc mount 406. Alternatively, each mini disc cutter 408 may extend in a plane that forms an angle with respect to the longitudinal plane of the disc mount 406, the rock breaker tool 28, 400 being configured such that said angle is adjustable. Once inserted at least partially into the slot 20, 22, the rock breaker tool 28, 400 is operable to cut into the rock pillar using the mini disc cutters 408 on the tool head 402. In this way, cracks in the rock 12 may be initiated at multiple locations, which facilitates subsequent retrieval of the broken rock formation. This particular approach to rock breaking advantageously uses the least energy to break the rock along a predetermined direction.

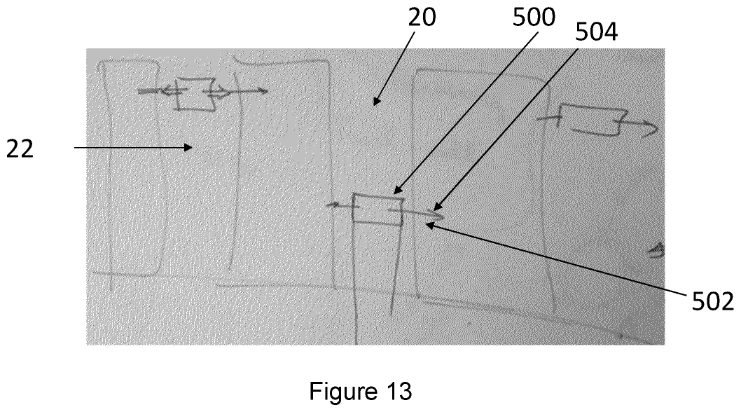

In the example indicated in FIG. 13, the rock breaker tool 28 has a tool head 500 that comprises one or more strike elements 502 actuatable to extend outwardly and to retract inwardly using, for example, hydraulic expanders. The strike element(s) 502 may comprise a superhard strike tip 504. In use, the strike element(s) 502 is (are) fired, i.e. rapidly deployed, from the tool head 500 towards the adjacent rock 12. This may cause the aforementioned indentations in the rock 12. Impact from the strike tips 504, and ergo the indentations, can be sufficient to initiate cracks and subsequent propagation. Again, this facilitates subsequent retrieval of the broken rock formation. Optionally, two opposing strike elements 502 are fired towards pillars of rock 12 on either side of the slot 20, 22.

Optionally and as seen in FIG. 13, multiple tool heads may be deployed to actuate in positions at multiple depths within the slot 20, 22 to force fracture of the rock 12.

In summary, the inventors have developed an improved method of mining which minimises the energy required to break rock, particularly in hard rock mining.

While this invention has been particularly shown and described with reference to embodiments, it will be understood by those skilled in the art that various changes in form and detail may be made without departing from the scope of the invention as defined by the appended claims.

1. A method of mining rock using a disc cutter comprising a cutter body with a diameter, d, and a thickness, t, a plurality of tool holders mounted about a peripheral surface of the cutter body and a plurality of cutting elements attached to the tool holders, the method comprising the steps:
cutting a first slot in the rock at a first cutting position of the disc cutter,
moving the disc cutter to a second cutting position, and
cutting a second slot in the rock, such that the second slot is spaced apart from the first slot by distance S, at least one of the first and second slots having a depth of slot D, and wherein a ratio of depth of slot D, to distance S, is in the range of 2 to 16.

2. (canceled)

3. (canceled)

4. The method as claimed in claim 1, wherein the depth of slot D is in the range of 300 to 800 mm.

5. The method as claimed in claim 4, wherein the depth of slot D is in the range of 300 to 400 mm.

6. The method as claimed in claim 4, wherein the depth of slot D is in the range of 500 to 600 mm.

7. The method as claimed in claim 4, wherein the depth of slot D is in the range of 700 to 800 mm.

8. The method as claimed in claim 1, wherein the diameter, d, of the cutter body is in the range of 1.0 to 5.0 m.

9.-11. (canceled)

12. The method as claimed in claim 1, wherein the distance, S, is in the range of 50 to 200 mm.

13.-15. (canceled)

16. The method as claimed in claim 1, wherein the first and/or the second slot has a width, W, and the width is in the range of 20 to 80 mm.

17. The method as claimed in claim 16, wherein the slot width is 20 to 40 mm and the Unconfined Compressive Strength of the rock is 200 MPa or more.

18. The method as claimed in claim 16, wherein the slot width is 40 to 60 mm and the Unconfined Compressive Strength of the rock is in the range of 150 to 200 MPa.

19. The method as claimed in claim 16, wherein the slot width is 60 to 80 mm and the Unconfined Compressive Strength of the rock is in the range of 60 to 150 MPa.

20. The method as claimed in claim 16, wherein the slot width is 60 to 80 mm and the Unconfined Compressive Strength of the rock is in the range of 30 to 60 MPa.

21. The method as claimed in claim 1, further comprising at least partially inserting a rock breaker tool into the first and second slots.

22. The method as claimed in claim 1, wherein the method further comprises forming an indentation in rock adjacent to the first and/or second slots.

23. The method as claimed in claim 22, wherein the indentation is formed to a depth that is up to 20% of the distance S.

24. The method as claimed in claim 22, wherein the indentation is formed at a position located in the or each slot, which is measured away from an opening of the slot and equivalent to at least 15% of the depth of slot.

25. The method as claimed in claim 24, wherein the or each indentation is formed at or proximate to a floor of the slot.

26. The method as claimed in claim 22, comprising forming an indentation into adjacent rock of the first and second slots, wherein said indentations face each other.

27. A method of mining rock using a disc cutter comprising a cutter body with a diameter, d, a plurality of tool holders mounted about a peripheral surface of the cutter body and a plurality of cutting elements attached to the tool holders, the method comprising cutting a depth of slot D in the rock at a cutting position of the disc cutter, wherein a ratio of the depth of slot D to the diameter d of the cutter body is from approximately 0.15 to approximately 0.50.

28. The method as claimed in claim 27, wherein the ratio of the depth of slot D to the diameter d of the cutter body is from approximately 0.35 to approximately 0.40.
